(19) United States
(12) Patent Application Publication
(10) Pub. No.: US 2018/0314945 A1
(43) Pub. Date: Nov. 1, 2018

(54) GRAPH MATCHING FOR OPTIMIZED DEEP NETWORK PROCESSING

(71) Applicant: Advanced Micro Devices, Inc., Sunnyvale, CA (US)

(72) Inventors: Mauricio Breternitz, Austin, TX (US); Mayank Daga, Austin, TX (US)

(21) Appl. No.: 15/498,943

(22) Filed: Apr. 27, 2017

(51) Int. Cl. G06N 3/08; G06N 3/04

(52) U.S. Cl. CPC G06N 3/082; G06N 3/04

(57) ABSTRACT

Systems, apparatuses, and methods for enhanced resolution video and security via machine learning are disclosed. A system is configured to receive a source code representation of a neural network. In one embodiment, the source code representation is a directed acyclic graph (DAG). The system determines if the source code representation includes any of one or more patterns, with each pattern including two or more adjacent layers. The system also identifies, for each pattern, a combined layer with which to replace the detected pattern. If any occurrences of the one or more patterns are detected in the source code representation, the system replaces each pattern with a corresponding combined layer. Additionally, the system generates an optimized representation of the neural network, wherein the optimized representation includes replacements for any detected patterns. The optimized representation can be utilized to generate an executable version of the neural network.

### BACKGROUND

### Description of the Related Art

Neural networks are being used in increasing numbers and types of application. For example, neural networks have been used in the area of pattern recognition and classification. Neural networks can include collections of neurons that each has a receptive field and that collectively tile an input space. In a multi-layered neural network, the output of a first layer of neurons (or computation units) becomes an input to a second layer of neurons, the output of a second layer of neurons becomes and input to a third layer of neurons, and so on. Neural networks can be trained to recognize a hierarchy of features. Accordingly, neural networks have increasingly been used in object recognition and other applications.

In neural networks, computation can be distributed over a population of processing nodes, which can be configured in one or more computational chains. These multi-layered architectures can be trained one layer at a time and can be fine-tuned using back propagation. A neural network can be implemented on various types of computing devices which include a parallel processing architecture. The parallel processing architecture allows the neural network to be implemented more efficiently. However, despite the recent improvements of processing hardware, neural network implementations still suffer from long processing times, high power consumption, and other inefficiencies.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one embodiment of a computing system for implementing a neural network.

FIG. 2 is a block diagram of one embodiment of optimizing a portion of a directed acyclic graph (DAG).

FIG. 3 is a block diagram of one embodiment of a system for optimizing a neural network directed acyclic graph (DAG).

FIG. 4 is a diagram of one embodiment of combining operations.

FIG. 5 is a generalized flow diagram illustrating one embodiment of a method for combining layers of a neural network.

FIG. 6 is a generalized flow diagram illustrating another embodiment of a method for optimizing neural networks.

FIG. 7 is a generalized flow diagram illustrating one embodiment of a method for determining whether to replace detected patterns in a representation of a neural network.

### DETAILED DESCRIPTION OF EMBODIMENTS

In the following description, numerous specific details are set forth to provide a thorough understanding of the methods and mechanisms presented herein. However, one having ordinary skill in the art should recognize that the various embodiments may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Systems, apparatuses, and methods for optimizing a source code representation of a neural network are disclosed herein. In one embodiment, a system includes at least a processor coupled to a memory. In one embodiment, the system is configured to receive a source code representation of a neural network. In one embodiment, the source code representation is a directed acyclic graph (DAG). If the system determines that two or more adjacent layers in the source code representation match a first pattern, then the system replaces the two or more adjacent layers in the source code representation with a single combined layer. Additionally, the system generates an optimized representation of the neural network, wherein the optimized representation includes the single combined layer. The optimized representation can be utilized to generate an executable version of the neural network. When the executable version of the neural network is implemented on a target machine, the single combined layer can be invoked with a single kernel call.

In one embodiment, the system receives indications of one or more patterns to search for in the source code representation. Each pattern includes an identification of two or more adjacent layers. Also, for each pattern, the system receives a corresponding combined layer with which to replace the detected pattern. Next, the system determines if the source code representation includes any occurrences of the one or more patterns. Then, the system replaces any occurrences of the one or more patterns with corresponding combined layers.

In another embodiment, the system receives an indication of a size of an input dataset being processed by a neural network. When the system detects a second pattern in the source code representation of the neural network, the system identifies a second combined layer to use for optionally replacing the second pattern. Then, the system calculates, based on the size of the input dataset, the memory utilization of the second combined layer. Next, the system determines if the memory utilization is less than a programmable threshold. The system replaces the second pattern in the source code representation with the second combined layer responsive to determining the memory utilization is less than the threshold. Alternatively, the system keeps the second pattern in the source code representation responsive to determining the memory utilization is greater than or equal to the threshold.

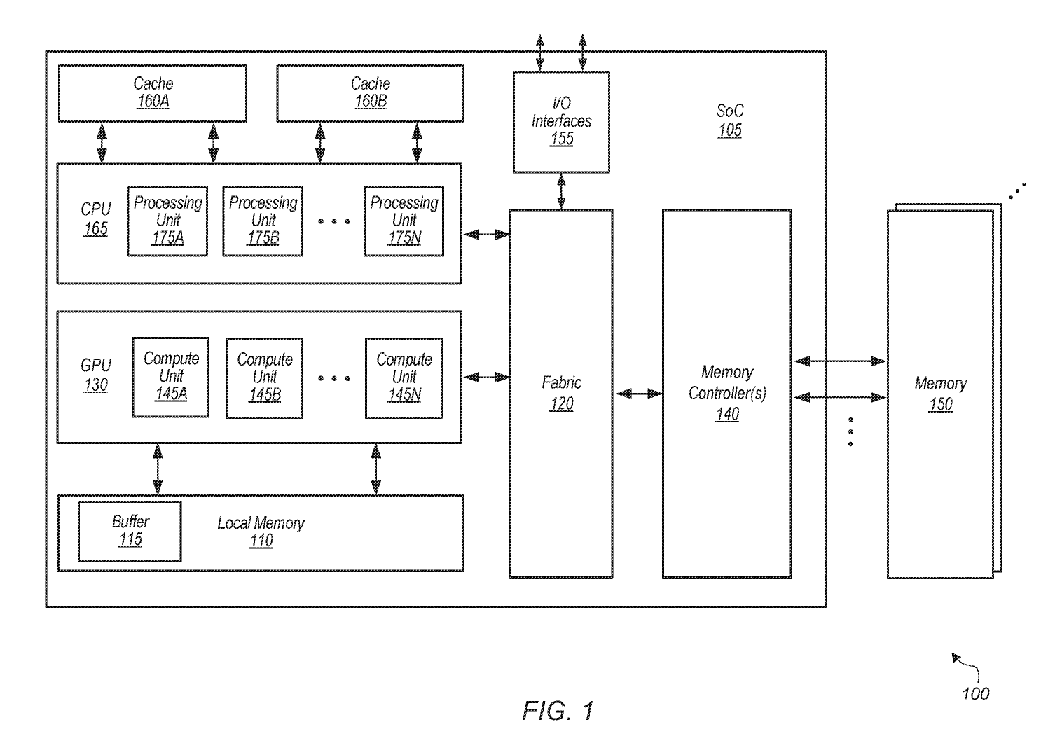

Referring now to FIG. 1, a block diagram of one embodiment of a computing system 100 for implementing a neural network is shown. In one embodiment, computing system 100 includes system on chip (SoC) 105 coupled to memory 150. SoC 105 can also be referred to as an integrated circuit (IC). In one embodiment, SoC 105 includes processing units 175A-N of central processing unit (CPU) 165, input/output (I/O) interfaces 155, caches 160A-B, fabric 120, graphics processing unit (GPU) 130, local memory 110, and memory controller(s) 140. SoC 105 can also include other components not shown in FIG. 1 to avoid obscuring the figure. Processing units 175A-N are representative of any number and type of processing units. In one embodiment, processing units 175A-N are CPU cores. In another embodiment, one or more of processing units 175A-N are other types of processing units (e.g., application specific integrated circuit (ASIC), field programmable gate array (FPGA), digital signal processor (DSP)). Processing units 175A-N of CPU 165 are coupled to caches 160A-B and fabric 120.

In one embodiment, processing units 175A-N are configured to execute instructions of a particular instruction set architecture (ISA). Each processing unit 175A-N includes one or more execution units, cache memories, schedulers, branch prediction circuits, and so forth. In one embodiment, the processing units 175A-N are configured to execute the main control software of system 100, such as an operating system. Generally, software executed by processing units 175A-N during use can control the other components of system 100 to realize the desired functionality of system 100. Processing units 175A-N can also execute other software, such as application programs.

GPU 130 includes at least compute units 145A-N which are representative of any number and type of compute units that are used for graphics or general-purpose processing. Each compute unit 145A-N includes any number of execution units, with the number of execution units per compute unit varying from embodiment to embodiment. GPU 130 is coupled to local memory 110 and fabric 120. In one embodiment, local memory 110 is implemented using high-bandwidth memory (HBM).

In one embodiment, GPU 130 is configured to implement a neural network on the plurality of compute units 145A-N, wherein different computations of the neural network are conveyed to different compute units of the plurality of compute units 145A-N. In one embodiment, the neural network is optimized prior to being implemented on GPU 130. The optimization involves combining together multiple layers of the neural network into a single combined layer which can be invoked with a single library call on GPU 130. In one embodiment, an optimizer (not shown) is configured to search for patterns in a directed acyclic graph (DAG) representation of the neural network and replace the patterns with more efficient operations. As used herein, the term “pattern” is defined as a predefined sequence of two or more consecutive layers within a data structure or source code representation (e.g., DAG). The term “layer” is defined as an operation or set of operations performed on data generated (or provided) by a prior stage of the neural network. The first layer of a neural network operates on an input dataset (e.g., an image).

The optimizer is configured to search for one or more predefined patterns in the source code representation of the neural network. If the optimizer detects a predefined pattern in the source code representation of the neural network, the optimizer can replace the predefined pattern with a single library call. For example, a first pattern can be defined as a convolution layer followed by an activation layer. If the optimizer detects the first pattern in the source code representation, the optimizer can replace the first pattern with a single library call which performs the combined operations of a convolution layer and an activation layer. In many cases, the single library call can be performed more efficiently than implementing a first library call for the convolution layer and a second library call for the activation layer. Other patterns can also be defined for adjacent neural network layers which can be combined together and performed by a single library call. For example, a second pattern can be defined as a convolution layer followed by a pooling layer, a third pattern can be defined as a convolution layer followed by a convolution layer, and so on. After analyzing the entire source code representation and replacing detected patterns with corresponding library calls, the optimizer outputs an optimized source code representation of the neural network which is used to generate an executable version of the neural network. Then, the executable version of the neural network is implemented on GPU 130 of system 100.

I/O interfaces 155 are coupled to fabric 120, and I/O interfaces 155 are representative of any number and type of interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices can be coupled to I/O interfaces 155. Such peripheral devices include (but are not limited to) displays, keyboards, mice, printers, scanners, joysticks or other types of game controllers, media recording devices, external storage devices, network interface cards, and so forth.

SoC 105 is coupled to memory 150, which includes one or more memory modules. Each of the memory modules includes one or more memory devices mounted thereon. In some embodiments, memory 150 includes one or more memory devices mounted on a motherboard or other carrier upon which SoC 105 is also mounted. In one embodiment, memory 150 is used to implement a random access memory (RAM) for use with SoC 105 during operation. The RAM implemented can be static RAM (SRAM), dynamic RAM (DRAM), Resistive RAM (ReRAM), Phase Change RAM (PCRAM), or any other volatile or non-volatile RAM. The type of DRAM that is used to implement memory 150 includes (but is not limited to) double data rate (DDR) DRAM, DDR2 DRAM, DDR3 DRAM, and so forth. Although not explicitly shown in FIG. 1, SoC 105 can also include one or more cache memories that are internal to the processing units 175A-N and/or compute units 145A-N. In some embodiments, SoC 105 includes caches 160A-B that are utilized by processing units 175A-N. In one embodiment, caches 160A-B are part of a cache subsystem including a cache controller.

It is noted that the letter “N” when displayed herein next to various structures is meant to generically indicate any number of elements for that structure (e.g., any number of processing units 175A-N in CPU 165, including one processing unit). Additionally, different references within FIG. 1 that use the letter “N” (e.g., compute units 145A-N) are not intended to indicate that equal numbers of the different elements are provided (e.g., the number of processing units 175A-N in CPU 165 can differ from the number of compute units 145A-N of GPU 130).

In various embodiments, computing system 100 can be a computer, laptop, mobile device, server or any of various other types of computing systems or devices. It is noted that the number of components of computing system 100 and/or SoC 105 can vary from embodiment to embodiment. There can be more or fewer of each component/subcomponent than the number shown in FIG. 1. It is also noted that computing system 100 and/or SoC 105 can include other components not shown in FIG. 1. Additionally, in other embodiments, computing system 100 and SoC 105 can be structured in other ways than shown in FIG. 1.

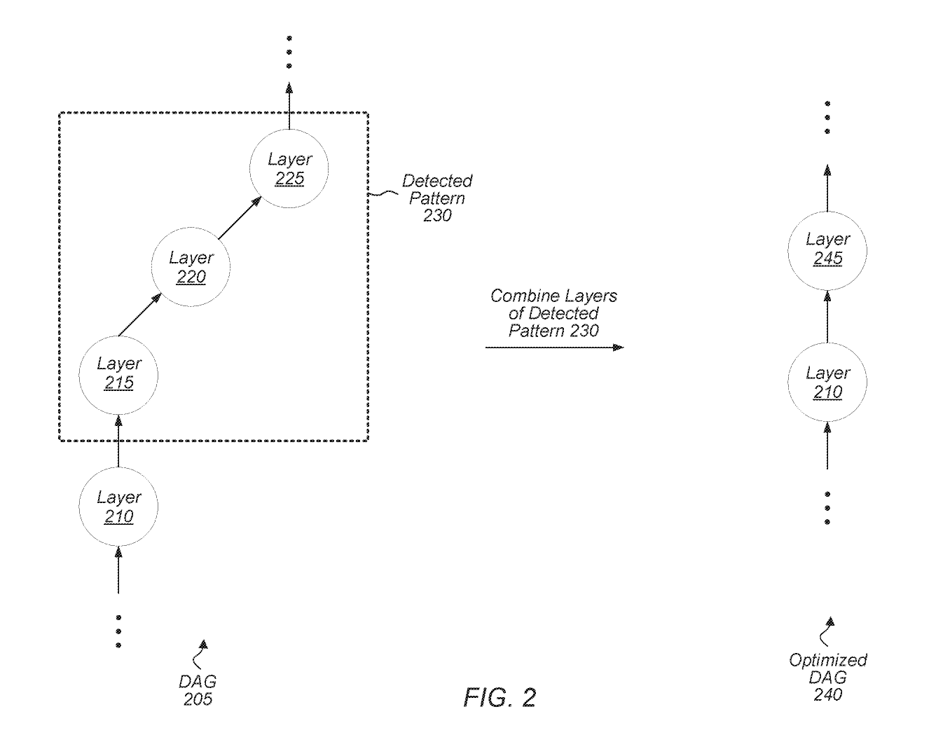

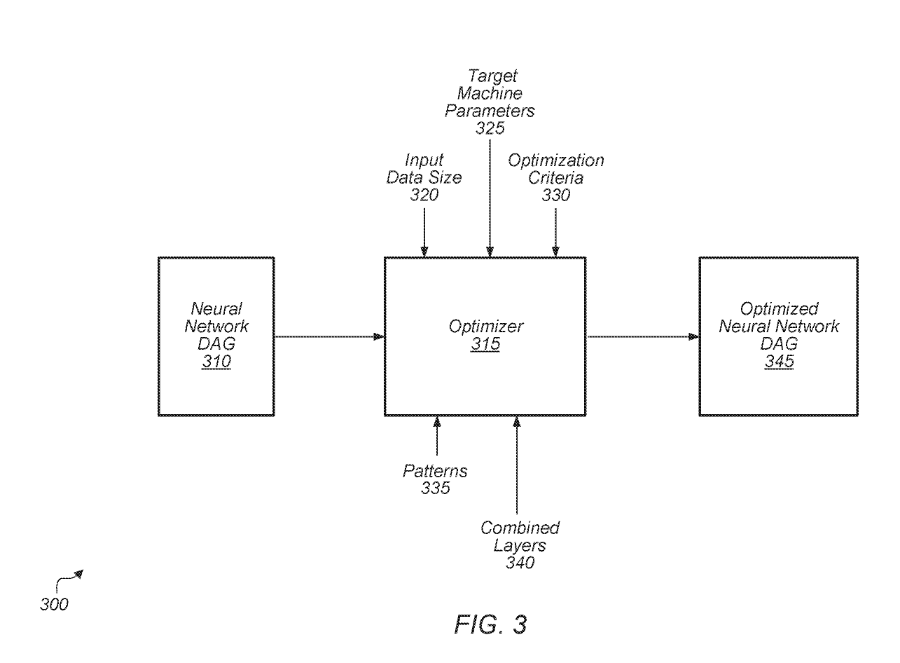

Turning now to FIG. 2, a block diagram of one embodiment of optimizing a portion of a directed acyclic graph (DAG) 205 is shown. DAG 205 is representative of the structure of a neural network. Only a portion of the entire DAG 205 is shown in FIG. 2. An optimizer (e.g., optimizer 315 of FIG. 3) is configured to receive DAG 205 and perform an analysis of DAG 205 to determine if DAG 205 includes one or more patterns (e.g., pattern 230) of adjacent layers which can be combined.

Layers 210, 215, 220, and 225 are representative of any type of layers. For example, layers which can be included in DAG 205 include, but are not limited to, a convolution layer, pooling layer, activation layer, subsampling layer, normalization layer, and/or other layers. When executed by a target computing system (e.g., system 100 of FIG. 1), each layer 210-225 will be implemented by invoking a separate kernel. Accordingly, the target computing system will implement four kernel calls to invoke the four layers 210-225 of DAG 205.

It is assumed for the purposes of this discussion that the connections of layer 215 to layer 220 to layer 225 matches a given pattern 230 being searched for by the optimizer. Accordingly, the optimizer will replace the layers of detected pattern 230 with a single layer 245. Layer 245 will combine the operations of layer 215, 220, and 225 in a single kernel. Accordingly, the output from the optimizer is optimized DAG 240. The portion of optimized DAG 240 shown in FIG. 2 includes two separate layers which can be implemented on the computing system with two kernel calls. This is an improvement over DAG 205 which can be implemented with four kernel calls.

Referring now to FIG. 3, a block diagram of one embodiment of a system 300 for optimizing a neural network directed acyclic graph (DAG) 310 is shown. In one embodiment, a structure of a neural network is represented as a DAG 310. An example of a portion of a neural network DAG is shown in FIG. 2. Within a neural network DAG, the nodes represent layers of the network and the edges represent the transfer of data between layers.

Neural network DAG 310 is provided as an input to optimizer 315. Additionally, other inputs provided to optimizer 315 include input data size 320, target machine parameters 325, optimization criteria 330, patterns 335, and combined layers 340. In other embodiments, optimizer 315 can receive a subset of these inputs and/or receive other inputs. Input data size 320 includes an indication of the size of the input dataset which will be processed by the neural network of which neural network DAG 310 is a representation. In some embodiments, the size of the input dataset may be unknown, and input data size 320 can be omitted in those embodiments. Target machine parameters 325 include a specification (e.g., memory capacity, number of compute units) of the target machine which will be implementing the neural network. In some cases, the target machine may not be known, and target machine parameters 325 can be omitted in these embodiments.

Optimization criteria 330 includes one or more criteria or goals (e.g., performance target, power target) that are desired to be met when implementing the neural network. Patterns 335 include one or more patterns of layers which, if found within neural network DAG 310, can be replaced with a single combined layer. For each pattern 335 provided to optimizer 315, a combined layer 340 is provided which can be used to replace the detected pattern 335. Optimizer 315 utilizes these inputs to analyze and modify neural network DAG 310 to generate optimized neural network DAG 345. In one embodiment, any patterns found in neural network DAG 310 can be replaced with corresponding combined layers 340 when optimizer 315 generates optimized neural network DAG 345. Depending on the embodiment, optimizer 315 can be implemented using any suitable combination of hardware and/or software. In one embodiment, optimizer 315 is a tool such as a compiler or compiler like tool that includes functionality to analyze graph structures. In another embodiment, optimizer 315 conveys optimized neural network DAG 345 to a separate compiler.

In one embodiment, optimizer 315 can perform graph covering techniques on neural network DAG 310 to generate multiple different versions of optimized neural network DAG 345. Optimizer 315 is configured to generate a cost estimate of each different version to determine which version of optimized neural network DAG 345 has the lowest cost. The cost estimate can be generated based on the different optimization criteria 330 provided to optimizer 315. Accordingly, optimizer 315 can utilize the version with the lowest cost for the final solution which is generated as optimized neural network DAG 345.

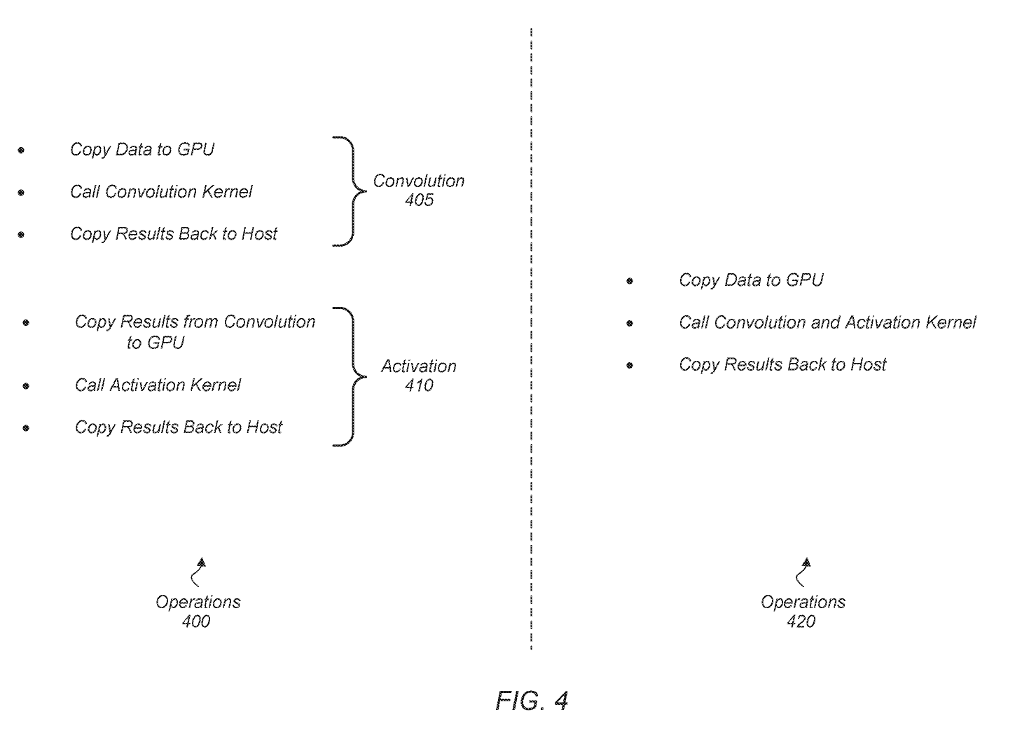

Turning now to FIG. 4, a diagram of one embodiment of combining operations is shown. Operations 400 are shown on the left-side of FIG. 4, and operations 400 include a convolution operation 405 and an activation operation 410. At the start of each operation, data is copied to the GPU and at the end of each operation, results are copied back to the host. Convolution operation 405 and activation operation 410 are examples of operations which can be combined to generate a more efficient implementation.

Operations 420 are shown on the right-side of FIG. 4, and operations 420 include a single kernel which combines the convolution and activation operations. Accordingly, operations 420 can be performed with two fewer data copies and one fewer GPU kernel invocation as compared to operations 400. In one embodiment, an optimizer (e.g., optimizer 315 of FIG. 3) is configured to convert operations 400 into operations 420. The optimizer is configured to search for operations (e.g., a convolution followed by an activation) which can be combined into a single kernel invocation. In other embodiments, other operations can be combined together. For example, a convolution operation followed by a pooling operation can be combined into a single kernel. Additionally, in some cases, two or more convolution operations can be combined into a single kernel.

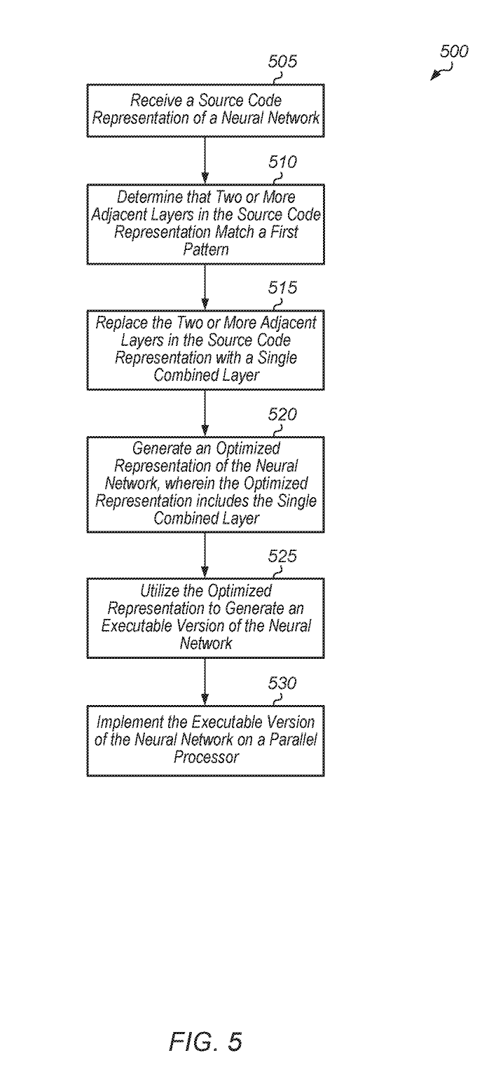

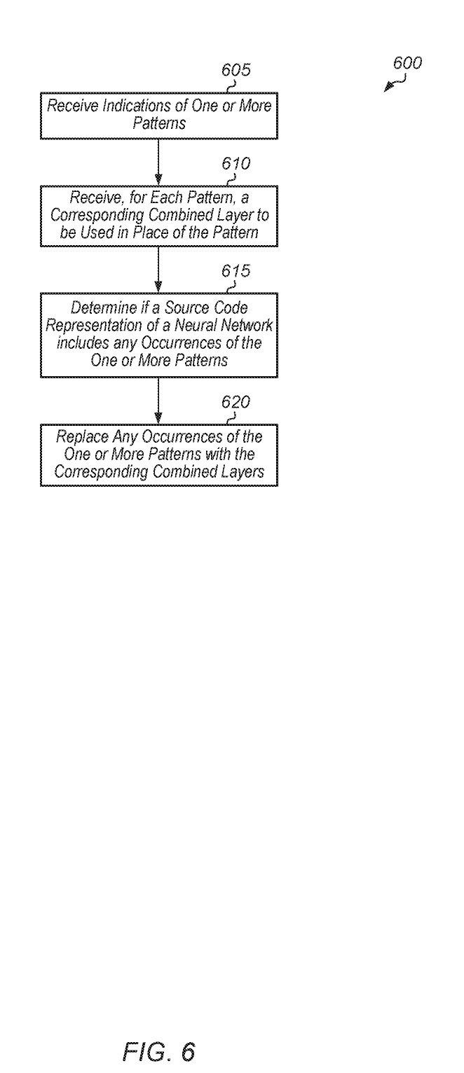

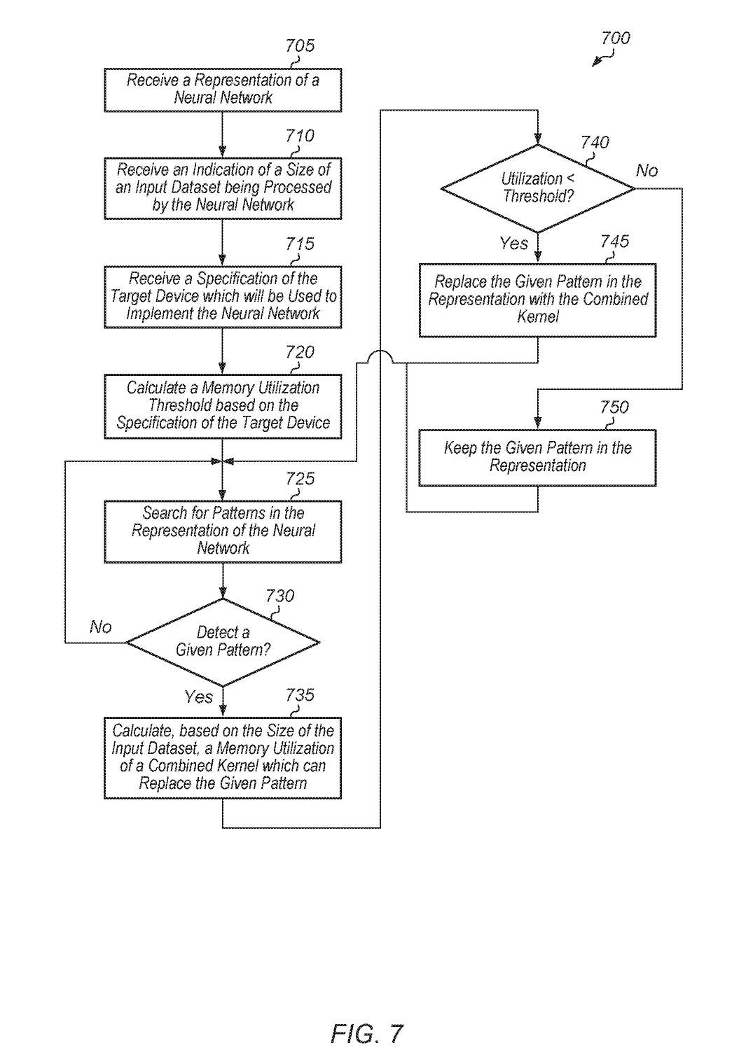

Referring now to FIG. 5, one embodiment of a method 500 for combining layers of a neural network is shown. For purposes of discussion, the steps in this embodiment and those of FIGS. 6-7 are shown in sequential order. However, it is noted that in various embodiments of the described methods, one or more of the elements described are performed concurrently, in a different order than shown, or are omitted entirely. Other additional elements are also performed as desired. Any of the various systems or apparatuses described herein are configured to implement method 500.

A computing system receives a source code representation of a neural network (block 505). In one embodiment, the source code representation is a directed acyclic graph (DAG). Next, the system determines that two or more adjacent layers in the source code representation match a first pattern (block 510). When the source code representation is a DAG, the two or more adjacent layers correspond to two or more adjacent nodes in the DAG. Then, the system replaces the two or more adjacent layers in the source code representation with a single combined layer (block 515). Next, the system generates an optimized representation of the neural network, wherein the optimized representation includes the single combined layer (block 520). Then, the optimized representation is utilized to generate an executable version of the neural network (block 525). Then, the executable version of the neural network is implemented on a parallel processor (e.g., GPU) (block 530). After block 530, method 500 ends.

Turning now to FIG. 6, one embodiment of a method 600 for optimizing neural networks is shown. An optimizer receives indications of one or more patterns (block 605). In one embodiment, the optimizer includes program instructions which are executable on any of various types of computing systems. The type of computing system can vary from embodiment to embodiment. The optimizer receives, for each pattern, a corresponding combined layer to be used in place of the pattern (block 610). Next, the optimizer determines if a source code representation of a neural network includes any occurrences of the one or more patterns (block 615). Then, the optimizer replaces any occurrences of the one or more patterns with corresponding combined layers (block 620). After block 620, method 600 ends.

Turning now to FIG. 7, one embodiment of a method 700 for determining whether to replace detected patterns in a graph, such as a representation of a neural network, is shown. An optimizer executing on a computing system receives or otherwise accesses a representation of a neural network (block 705). In one embodiment, the representation is a DAG. Also, the optimizer receives or otherwise determines an indication of a size of an input dataset being processed by the neural network (block 710) and a specification of the target device which will be used to implement the neural network (block 715). In various embodiments, the specification can include, or otherwise be indicative of, the amount of memory available to the various compute units of the target device. Next, the optimizer calculates a memory utilization threshold based on the specification of the target device (block 720).

Next, the optimizer searches for patterns in the representation of the neural network (block 725). If the optimizer detects a given pattern in a portion of the representation (conditional block 730, “yes” leg), then the optimizer calculates, based on the size of the input dataset, a memory utilization of a combined kernel which can replace the given pattern (block 735). In one embodiment, memory utilization is calculated as the sum of memory used by all of the operations of the second combined layer. If the optimizer does not detect a given pattern in the portion of the representation (conditional block 730, “no” leg), then the optimizer returns to block 725 to search other portions of the representation for patterns.

If the optimizer determines that the calculated memory utilization is less than a programmable threshold (conditional block 740, “yes” leg), then the optimizer replaces the given pattern in the representation with a combined kernel (block 745). In one embodiment, the memory utilization threshold calculated in block 720 is utilized as the programmable threshold in conditional block 740. If optimizer determines that the calculated memory utilization is greater than or equal to the programmable threshold (conditional block 740, “no” leg), then the optimizer keeps the first pattern in the representation (block 750). After blocks 745 and 750, method 700 returns to block 725 to continue searching for patterns in other portions of the representation. If the entire representation has already been searched, then method 700 ends.

In various embodiments, program instructions of a software application are used to implement the methods and/or mechanisms previously described. The program instructions describe the behavior of hardware in a high-level programming language, such as C. Alternatively, a hardware design language (HDL) is used, such as Verilog. The program instructions are stored on a non-transitory computer readable storage medium. Numerous types of storage media are available. The storage medium is accessible by a computing system during use to provide the program instructions and accompanying data to the computing system for program execution. The computing system includes at least one or more memories and one or more processors configured to execute program instructions.

It should be emphasized that the above-described embodiments are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A system comprising:
a memory; and
a processor coupled to the memory;
wherein the system is configured to:
receive a source code representation of a neural network;
determine that two or more adjacent layers in the source code representation match a first pattern;
replace the two or more adjacent layers in the source code representation with a single combined layer; and
generate an optimized representation of the neural network, wherein the optimized representation includes the single combined layer.

2. The system as recited in claim 1, wherein the system is configured to:
receive indications of one or more patterns;
receive, for each pattern, a corresponding combined layer;
determine if the source code representation includes any occurrences of the one or more patterns; and
replace any occurrences of the one or more patterns with corresponding combined layers.

3. The system as recited in claim 2, wherein the source code representation is a directed acyclic graph (DAG).

4. The system as recited in claim 3, wherein each pattern, of the one or more patterns, comprises two or more adjacent nodes in the DAG.

5. The system as recited in claim 1, wherein the system is further configured to:
receive an indication of a size of an input dataset being processed by the neural network;
detect a second pattern in the source code representation, wherein the second pattern comprises two or more adjacent layers;
identify a second combined layer for optionally replacing the second pattern;
calculate, based on the size of the input dataset, a memory utilization of the second combined layer;
replace the second pattern in the source code representation with the second combined layer responsive to determining the memory utilization is less than a threshold; and
keep the second pattern in the source code representation responsive to determining the memory utilization is greater than or equal to the threshold.

6. The system as recited in claim 1, wherein a single kernel is invoked to perform operations of the single combined layer.

7. The system as recited in claim 1, wherein the optimized representation is utilized to generate an executable version of the neural network.

8. A method comprising:
receiving a source code representation of a neural network;
determining that two or more adjacent layers in the source code representation match a first pattern;
replacing the two or more adjacent layers in the source code representation with a single combined layer; and
generating an optimized representation of the neural network, wherein the optimized representation includes the single combined layer.

9. The method as recited in claim 8, further comprising:
receiving indications of one or more patterns;
receiving, for each pattern, a corresponding combined layer;
determining if the source code representation includes any occurrences of the one or more patterns; and
replacing any occurrences of the one or more patterns with corresponding combined layers.

10. The method as recited in claim 9, wherein the source code representation is a directed acyclic graph (DAG).

11. The method as recited in claim 10, wherein each pattern, of the one or more patterns, comprises two or more adjacent nodes in the DAG.

12. The method as recited in claim 8, further comprising:
receiving an indication of a size of an input dataset being processed by the neural network;
detecting a second pattern in the source code representation, wherein the second pattern comprises two or more adjacent layers;
identifying a second combined layer for optionally replacing the second pattern;
calculating, based on the size of the input dataset, a memory utilization of the second combined layer;
replacing the second pattern in the source code representation with the second combined layer responsive to determining the memory utilization is less than a threshold; and
keeping the second pattern in the source code representation responsive to determining the memory utilization is greater than or equal to the threshold.

13. The method as recited in claim 8, wherein a single kernel is invoked to perform operations of the single combined layer.

14. The method as recited in claim 8, wherein the optimized representation is utilized to generate an executable version of the neural network.

15. A non-transitory computer readable storage medium storing program instructions, wherein the program instructions are executable by a processor to:
receive a source code representation of a neural network;
determine that two or more adjacent layers in the source code representation match a first pattern;
replace the two or more adjacent layers in the source code representation with a single combined layer; and
generate an optimized representation of the neural network, wherein the optimized representation includes the single combined layer.

16. The non-transitory computer readable storage medium as recited in claim 15, wherein the program instructions are further executable by a processor to:
receive indications of one or more patterns;
receive, for each pattern, a corresponding combined layer;
determine if the source code representation includes any occurrences of the one or more patterns; and
replace any occurrences of the one or more patterns with corresponding combined layers.

17. The non-transitory computer readable storage medium as recited in claim 16, wherein the source code representation is a directed acyclic graph (DAG).

18. The non-transitory computer readable storage medium as recited in claim 17, wherein each pattern, of the one or more patterns, comprises two or more adjacent nodes in the DAG.

19. The non-transitory computer readable storage medium as recited in claim 15, wherein the program instructions are further executable by a processor to:
receive an indication of a size of an input dataset being processed by the neural network;
detect a second pattern in the source code representation, wherein the second pattern comprises two or more adjacent layers;
identify a second combined layer for optionally replacing the second pattern;
calculate, based on the size of the input dataset, a memory utilization of the second combined layer;
replace the second pattern in the source code representation with the second combined layer responsive to determining the memory utilization is less than a threshold; and
keep the second pattern in the source code representation responsive to determining the memory utilization is greater than or equal to the threshold.

20. The non-transitory computer readable storage medium as recited in claim 15, wherein a single kernel is invoked to perform operations of the single combined layer.
